(19) United States
(12) Patent Application Publication
(10) Pub. No.: US 2004/0198409 A1
(43) Pub. Date: Oct. 7, 2004

(54) Wireless digital key telephone system

(76) Inventor: Heng-Chien Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,296

(22) Filed: Jun. 28, 2002

(30) Foreign Application Priority Data
May 23, 2002 (TW) 091110958

(51) Int. Cl. H04B 1/38

(52) U.S. Cl. 455/550.1

(57) ABSTRACT

A wireless digital Key Telephone System (KTS) includes at least one extension. The extension contains an audio processing circuit that is electrically connected to a central processing circuit, a speaker, and a microphone. The audio processing circuit is responsible for transmitting audio signals outputted from the central processing circuit to the speaker, and transmitting audio signals received by the microphone to the central processing circuit. The extension also contains a network controller, which is electrically connected to the central processing circuit and to a network port. The network controller is responsible for the transmission of network signals between the central processing circuit and the network port.

### BACKGROUND OF INVENTION

1. Field of the Invention

The invention is related to a telephone system, and more particularly, to a wireless digital key telephone system (KTS) having the simultaneous functions of audio signal exchange and network signal delivery.

2. Description of the Prior Art

Due to the worldwide trend of telecommunication liberation and state-level fundamental construction of the information industry, the global communication device market has shown an enormous amount of demand and business opportunity in recent years. Therefore, the development of the communication device industry has become an important factor in further economic development.

Generally speaking, wired telephone systems become popular with economic growth. Users can communicate with people at different locations through a telephone in hand, while the connection between them is primarily through a switch system by system providers. The switch system is connected to multiple users and the connections between the users can be constructed through the switching system in order to exchange audio signals.

The same telephone exchange structure also is widely used by corporations for their internal communication and information exchange. The most frequently used systems are a Private Branch Exchange (PBX) and a Key Telephone System (KTS). These are analog switch systems. To implement this system in an office, extensions are placed according to employees” seat layout, while a switch is set to manage extension-to-extension and extension-to-outgoing line connections. By doing so, employees can communicate between extensions and with outsiders through outgoing lines.

A conventional KTS is cord-based, therefore construction must be done according to an office layout. This usually causes difficulty in construction and raises costs. Moreover, when the office layout has to be changed, the wiring must also be changed accordingly to maintain functionality in the working environment. Additionally, the conventional KTS does not provide the function of data networking. Therefore, when corporations want to build up a data network, all the in-place hardware such as wiring must be re-done despite the existing telephone system, wasting resources and creating potential problems for office management.

On the other hand, the use of a digital signal application instead of an analog signal in wireless telephony technology has been developed, but there are still some limitations due to interference between channels. A Digital Enhanced Cordless Telecommunication (DECT) system, which digitizes the signal and utilizes a Time Division Multiple Access (TDMA) protocol, was defined in 1992 in order to satisfy the increasing service density and quantity requirements. Under this specification, either a conventional analog or a digital switch system can transfer audio signals into wireless digitized signals resulting in much better distance and power than the conventional analog wireless telephony because of the use of high frequency channels. A digitized radio signal can avoid interference and preserve privacy. The wireless nature also simplifies the physical construction of the system.

However, the DECT system can only be integrated into a communication system of a corporation by connecting a radio exchange between the DECT system and an existing PBX system. All the signals must pass through the radio exchange before they can be transmitted in the DECT system. This structure will not be suitable for the KTS in wide use among corporations today. This is because the conventional KTS does not have a standard interface with the DECT system. Therefore, it is not easy to integrate two different telephone systems to simultaneously provide an audio signal switching mechanism and a wireless transmitting mechanism as can be done with the PBX system. Furthermore, the devices used in the DECT are relatively expensive compared with the ones in the KTS, and the DECT cannot provide enough bandwidth to support a data network. As a result, corporations still have to pay extra expenses for a proper network system.

### SUMMARY OF INVENTION

It is therefore a primary objective of the claimed invention to provide a wireless Digital Key Telephone System (KTS) with the simultaneous functions of audio signal switching and network data signal transmitting to solve the above-mentioned problem.

According to the claimed invention, a telephone system has at least one extension. The telephone system includes a central processing circuit for controlling the operation of the extension, an audio processing circuit electrically connected to the central processing circuit, a speaker, and a microphone. The speaker is used for broadcasting signals coming from the central processing circuit and the microphone receives signals and sends the received signals to the central processing circuit. The telephone system also includes a network controller electrically connected to the central processing circuit and a network port for transmitting network signals outputted from the central processing circuit to the network port and transmitting network signals received by the network port to the central processing circuit.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of a wireless digital key telephone system according to present invention.

FIG. 2 is a function block diagram of the telephone exchange shown in FIG. 1.

FIG. 3 is a function block diagram of the extension shown in FIG. 1.

### DETAILED DESCRIPTION

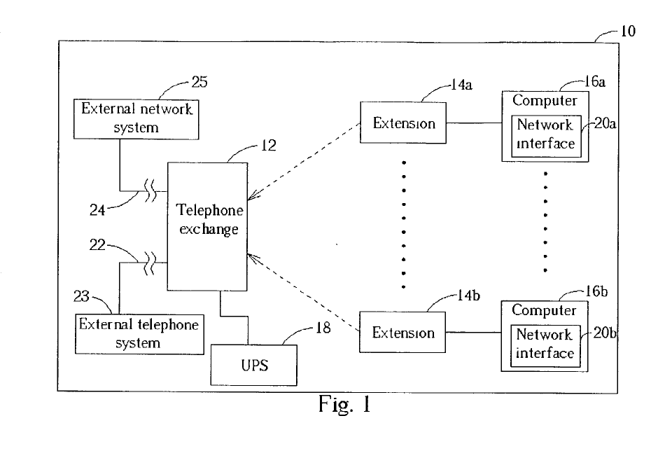

FIG. 1 shows a block diagram of a wireless Digital Key Telephone System (KTS) 10 according to present invention. The wireless digital KTS 10 comprises a telephone exchange 12, at least one extension 14a, 14b, at least one computer 16a, 16b, and an uninterruptible power supply (UPS) 18. The telephone exchange 12 is responsible for the switching and transmitting of audio signals and network signals. The extension 14 is used for receiving and transmitting audio and network signals from and to the telephone exchange 12 through wireless transmission. In addition, the extensions 14a, 14b are connected to the computer 16. The computer 16 comprises a network interface 20a, 20b for network communication.

When considering the transmission of network signals, the computer 16a can send out a network signal to the extension 14a through the network interface 20a. After receiving the signal, the extension 14a will transmit the signal to the telephone exchange 12 by way of wireless transmission. Then the telephone exchange 12 can broadcast the signal to extension 14b, again through wireless transmission. Because each network signal comprises information indicating the network address, the telephone exchange 12 will be able to transmit the signal to a specific computer, say 16b, through the extension 14b and the network interface 20b, consecutively.

Through the mechanism mentioned above, the computer 16a can form a local area network (LAN) utilizing the telephone exchange 12. Besides, the telephone exchange 12 can also be connected to an external network system 25, for example the Internet, through line 24. As a result, the computer 16 can be connected to the external network system 25.

Now consider the transmission of audio signals. When the telephone exchange 12 receives signals assigned to the extension 14b coming from external telephone system through a trunk line 22, the telephone exchange 12 will deliver the audio signals to the assigned extension 14b through wireless transmission. In other words, a connection has been built between the trunk line 22 and the extension 14b. In addition, when extension 14a would like to transmit signals to extension 14b, a connection between extensions 14a and 14b can be built through the wireless transmission of the telephone exchange 12 to each extension 14. The telephone exchange 12 and the extension 14 of the wireless digital KTS 10 according to the present invention will be described as follows.

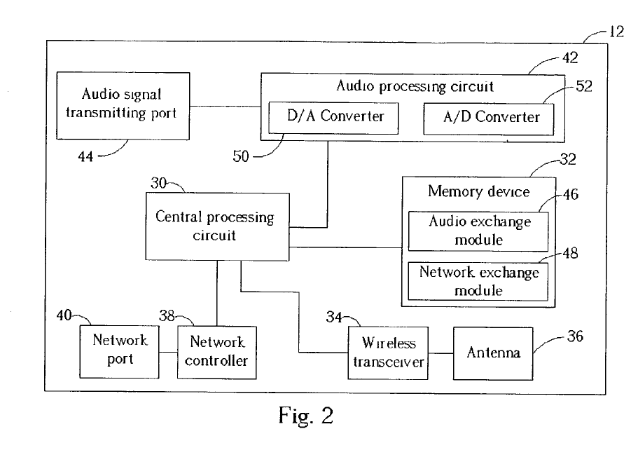

FIG. 2 shows a block diagram of the telephone exchange 12 of FIG. 1. It contains a central processing circuit 30, a memory device 32, a wireless transceiver 34, an antenna 36, a network controller 38, a network port 40, an audio processing circuit 42, and an audio signal transmitting port 44. The central processing circuit is responsible for the control of the switching of the telephone exchange 12.

The memory device 32 is connected to the central processing circuit 30 and is used for saving commands and data. The memory device comprises an audio exchange module 46 for processing the audio signals between the telephone exchange 12 and the extension 14, and a network exchange module 48 for processing the network signals between the telephone exchange 12 and the extension 14. The wireless transceiver 34 is connected to the central processing circuit 30 and is used for transmitting and receiving audio and network signals in a wireless fashion. The network controller 38 is connected to both the central processing circuit 30 and the network port 40. At the same time the network port 40 is connected to the external network system 25 through line 24, as shown in FIG. 1. Under this setup, network signals can be delivered between the central processing circuit 30 and the network port 40 through network controller 38.

The audio processing circuit 42 is electrically connected to both the central processing circuit 30 and the audio signal transmitting port 44, at the same time the audio transmitting port 44 is connected to the external telephone system 23 through the trunk line 22 as shown in FIG. 1. Under this setup, audio signals can be delivered between the central processing circuit 30 and the audio signal transmitting port 44 through the audio processing circuit 42.

The audio processing circuit 42 comprises a D/A converter 50 and an A/D converter 52. The audio signals are transmitted from the external telephone system 23 in analog format, but they are processed and transmitted within the telephone exchange 12 and between the telephone exchange 12 and the extension 14 in digital format. The two converters 50 and 52 are used for the conversion between digital and analog audio signals such that the telephone exchange 12 and the external telephone system 23 can communicate properly.

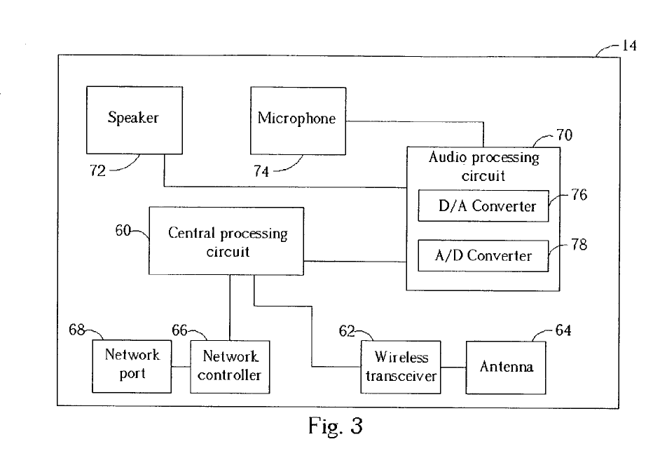

FIG. 3 shows the block diagram of the extension 14 of FIG. 1. The extension 14 contains a central processing circuit 60, a wireless transceiver 62, an antenna 64, a network controller 66, a network port 68, an audio processing circuit 70, a speaker 72, and a microphone 74. The central processing circuit 60 is responsible for the control of the extension 14.

The wireless transceiver 62 is electrically connected to the central processing circuit 60 and is used for transmitting audio and network signals to the antenna 36 and receiving them from the wireless transceiver 62 through the antenna 64. The network controller 66 is electrically connected to both the central processing circuit 60 and the network port 68. At the same time the network port 68 is connected to the network interface 20 of the computer 16 in FIG. 1. Under this setup, network signals can be delivered between the central processing circuit 60 and the network port 68 through the network controller 66.

The audio processing circuit 70 is electrically connected to the central processing circuit 60, the speaker 72, and the microphone 74. Therefore, the audio processing circuit 70 can broadcast the audio signals from the central processing circuit 60 through the speaker 72, and collect the audio signals for the central processing circuit 60 through the microphone 74. The audio processing circuit 70 also comprises a D/A converter 76 and an A/D converter 78. The audio signals are processed and transmitted within the telephone exchange 12 and between the telephone exchange 12 and the extension 14 in digital format, but the broadcasting of them at the speaker 72 and the collecting of them at the microphone 74 are in analog format. The two converters 76 and 78 are used for the conversion between digital and analog audio signals such that the telephone exchange 12, the speaker 72, and the microphone 74 can cooperate properly. In the example, the speaker 72 and the microphone 74 are both set within a handset of the extension 14, but can be installed on the main body of the extension 14 for handset-free use. The interaction among the devices of the telephone exchange 12 and the extension 14 will be described as followed.

a.Audio Signal ExchangePlease refer to FIGS. 1, 2, and 3. When a user at the extension 14a tries to call a user at the extension 14b, the user at the extension 14a will dial the number of the extension 14b through a dial pad on a main body of the extension 14a. The telephone exchange 12 will build a channel connecting the extensions 14a and 14b. When the user at the extension 14b responds, the central processing circuit 30 will run the audio exchange module 46 in order to exchange the audio signals between the extensions 14a and 14b. More specifically, the microphone 74 of the extension 14a collects the analog audio signals from the user and sends them to the audio processing circuit 70. Then the signals are converted into digital audio signals through the A/D converter 78. The central processing circuit 60 transmits the digital audio signals to the wireless transceiver 62, then wirelessly to the telephone exchange 12 through the antenna 64. The wireless transceiver 34 of the telephone exchange 12 receives the digital audio signal from extension 14a through the antenna 36. Then the central processing circuit 30 runs the audio exchange module 46 to execute processes such as merging, sorting, switching, and reallocating of the signal, which usually is the case for KTS. After that, the audio exchange module 46 transmits the digital audio signal to extension 14b through the wireless transceiver 34 and the antenna 36. Finally, when the wireless transceiver 62 of the extension 14b receives the signals from the telephone exchange 12 through the antenna 64, the central processing circuit 60 delivers the signals to the audio processing circuit 70 in order to convert them into analog audio signals. Then the user at extension 14b can hear the broadcast from the speaker 72.

Similarly, when detecting a call from the external telephone system 23 through the trunk line 22, the telephone exchange 12 will also run the audio exchange module 46 in order to construct a channel between the caller and the extension 14. More specifically, when a user from the external telephone system 23 would like to call the user at the extension 14a, the audio signal transmitting port 44 of the telephone exchange 12 receives the analog audio signals from the external user. The signals are delivered to the audio processing circuit 42 and converted into digital audio signals by the A/D converter 52. Then central processing circuit 30 runs the audio exchange module 46 to execute processes such as merging, sorting, switching and reallocating of the signal. After that, the audio exchange module 46 transmits the digital audio signals wirelessly through the wireless transceiver 34 and the antenna 36 to the extension 14a. When the wireless transceiver 62 of the extension 14a receives the signals from the telephone exchange 12 through the antenna 64, the signals are delivered by the central processing circuit 60 to the audio processing circuit 70, then converted into digital audio signals by the D/A converter 76. Finally, the signals are broadcast by the speaker 72 and reach the user at the extension 14a.

This also works similarly from the other direction. The microphone 74 of the extension 14a collects the analog audio signals from a user. The signals are delivered to the audio processing circuit 70 and converted into digital audio signals by the A/D converter 78. Then the central processing circuit 60 transmits the signals wirelessly through the wireless transceiver 62 and the antenna 64 to the telephone exchange 12. The wireless transceiver 34 of the telephone exchange 12 receives the digital audio signals from the extension 14a through the antenna 36 and then the central processing circuit 30 runs the audio exchange module 46 to execute processes of the KTS. After being converted into analog audio signals by the D/A converter 50 of the audio processing circuit 42, the signals are transmitted to the external telephone system 23 through the audio transmitting port 44 and the trunk line 22.

b.Network Signal TransmissionPlease refer to FIGS. 1, 2, and 3. When the computer 16a sends data to the computer 16b, the telephone exchange 12 will run the network exchange module 48 in order to establish a network among the computers 16a and 16b, i.e., a local area network. More specifically, the computer 16a converts the data into network signals through the network interface 20a. The extension 14a receives the network signals through the network port 68 and then further transmits the network signals to the central processing circuit 60 through the network controller 66. The network signals are then transmitted through the wireless transceiver 62 and the antenna 64 using wireless transmission to the telephone exchange 12. After the wireless transceiver 34 of the telephone exchange 12 receives the network signals from the extension 14a through the antenna 36, the central processing circuit 30 will run the network exchange module 48. The module tells the wireless transceiver 34 to broadcast the network signals through the antenna 36 to every extension 14. The wireless transceiver 62 of each extension 14 will receive the network signals, and the central processing circuit 60 will deliver them to the network port 68 through the network controller 66. Since the network signals contain network address information, only the network interface 20b of the computer 16b can successfully receive the network signals and convert them back to correct data. Finally, the transmission of data in the opposite direction, i.e., from the computer 16 to the external network system 25 can be done in a similar fashion.

In an actual example, the network controller 38 of the telephone exchange 12 and the network controller 66 of the extension 14 can be network repeaters, which are to relay the network signal without distorting it. The telephone exchange 12 and the extensions 14 together form a wireless hub structure. Here, the extensions 14 can be considered as the ports of the hub. All the ports are wirelessly connected to the telephone exchange 12, and the network exchange module 48 is used by the telephone exchange 12 to communicate with these ports.

The network port 40 connected to the network controller 38 can be considered as an up-link port, which can be used to connect an external network system through a switch or a hub. In addition, the standard of the signals transmitted by the network controller 38 of the telephone exchange 12 and the network controller 66 of the extension 14 is compatible with the IEEE 802.3 standard defined by the Institute of Electrical and Electronic Engineers (IEEE). The connection standard of the network port 40 of the telephone exchange 12 and the network port 68 of the extension 14 is compatible with that of 10base-T, for example RJ-45. Any other connection standard that can achieve the network system requirement mentioned above should be considered within the scope of this invention.

In summary, the transmission of the audio and network signals between the telephone exchange 12 and the extension 14 is achieved through wireless transmission. The signal-transmitting standard of the wireless transceiver 34 of the telephone exchange 12 and the wireless transceiver 62 of the extension 14 is compatible with the IEEE 802.3 defined by IEEE or other standards, for example blue tooth or infrared ray transmission standard. Also, in order to function in future broadband environments, coding techniques such as Direct Sequence Spread Spectrum (DSSS) or Code-Division Multiple Access (CDMA) can be utilized by the wireless transceiver 34 of the telephone exchange 12 and the wireless transceiver 62 of the extension 14 in the transmission of audio and network signals. The applications mentioned above or any other broadband mechanism should be also be considered within the scope of this invention.

Compared to conventional technology, the wireless digital key telephone system disclosed by the present invention is able to integrate audio communication and network communication while utilizing the digital exchange system within the telephone exchange 12. Users can communicate using one extension of the wireless digital key telephone system in the present invention with other extensions of the same system, or with an external telephone system connected to the wireless digital key telephone system. Moreover, the wireless digital key telephone system in the present invention can build up a telephone system and a local area network (LAN) system at the same time.

The LAN system is constructed in the form of a hub structure combining the telephone exchange 12 and the extension 14. Each extension 14 can be considered as a port connecting to the computer 16, and the transmission of network signals between ports is controlled by the telephone exchange 12. Therefore, the present invention supports the function of both a telephone system and a network system at a considerable savings in cost. Additionally, in the wireless digital key telephone system of the present invention, the communication between the telephone exchange 12 and the extension 14 is done through wireless transmission, which obviously means wiring is not necessary. This also gives cost advantages and convenience for potential future changes.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A telephone system having at least one extension, the telephone system comprising:
a central processing circuit for controlling the operation of the extension;
an audio processing circuit electrically connected to the central processing circuit, a speaker and a microphone for transmitting audio signals received by the microphone to the central processing unit; and
a network controller electrically connected to the central processing circuit and a network port for transmitting network signals outputted from the central processing circuit to the network port and transmitting network signals received by the network port to the central processing circuit.

2. The telephone system of claim 1 being a wireless digital key telephone system for processing the transmission of the audio signals and the network signals, the wireless digital key telephone system further comprising:
a central processing circuit for controlling the operation of the telephone exchange;
a memory device electrically connected to the central processing circuit for storing programs and data;
a network exchange module stored in the memory device for processing the transmission of the network signals between the telephone exchange and each extension;
an audio exchange module stored in the memory device for processing the transmission of the audio signals between the telephone exchange and each extension; and
a transceiver electrically connected to the central processing circuit for wirelessly transmitting and receiving the network and audio signals through an antenna;
wherein the network signals from the network port and the audio signals from the microphone received by the extension are transmitted through the transceiver to the transceiver of the telephone exchange, the network exchange module and the audio exchange module process the network and audio signals then transmit the network and audio signals to the transceiver of other extensions through the network transceiver circuit in order to make the other extensions output the network and audio signals from the speaker and the network port.

3. The telephone system of claim 2 wherein the telephone exchange further comprises:
a network controller electrically connected to the central processing circuit; and
a network port for transmitting network signals outputted from the central processing circuit to the network port and transmitting network signals received by the network port to the central processing circuit.

4. The telephone system of claim 3 wherein the signal transmission in both the network controller of the telephone exchange and the network controller of the extension all meet the IEEE 802.3 communication protocol defined by IEEE (Institute of Electrical and Electronic Engineers, IEEE).

5. The telephone system of claim 3 wherein the network port of the telephone exchange and the network port of each extension are all of the media type, 10base-T.

6. The telephone system of claim 3 wherein the network controller of the telephone exchange and the network controller of the extension are all repeaters for relaying the network signals.

7. The telephone system of claim 2 wherein the telephone exchange further comprises an audio processing circuit electrically connected to the central processing circuit and a transmission port for transmitting the audio signals outputted from the central processing circuit to the transmission port or transmitting the audio signals received from the transmission port to the central processing circuit.

8. The telephone system of claim 7 wherein the telephone exchange comprises:
a Digital-to-Analog converter for transforming digital audio signals outputted from the central processing circuit into corresponding analog audio signals; and
an Analog-to-Digital converter for transforming analog audio signal received from the transmission port into corresponding digital audio signals.

9. The telephone system of claim 2 wherein the transceiver of the telephone exchange and the transceiver of the extension meet the IEEE 802.11 communication protocol defined by IEEE.

10. The telephone system of claim 2 wherein the transceiver of the telephone exchange and the transceiver of the extension transmit audio and network signals by direct sequence spread spectrum(Direct Sequence Spread Spectrum, DSSS).

11. The telephone system of claim 2 wherein the transceiver of the telephone exchange and the transceiver of each extension transmit audio and network signals by code-division multiple access(Code-Division Multiple Access, CDMA).

12. The telephone system of claim 1 wherein the network port of each extension is electrically connected to a computer system.

13. The telephone system of claim 1 wherein the audio processing circuit of the extension comprises:
a Digital-to-Analog converter for transforming the digital audio signals outputted from the central processing unit to the corresponding analog audio signals; and
an Analog-to-Digital converter for transforming the analog audio signals received from the microphone to the corresponding digital audio signals.

14. A method of signal processing for a telephone system having at least one extension, the method comprising:
a central processing circuit for controlling the operation of the extension;
an audio processing circuit electrically connected to the central processing circuit and a speaker and a microphone; and
a network controller electrically connected to the central processing circuit and a network port;
the method of signal processing comprising:
transmitting the audio signals outputted from the central processing circuit to the speaker and transmitting the audio signals received from the microphone to the central processing circuit; and
transmitting the network signals outputted from the central processing circuit to the network port, and transmitting the network signals received from the network port to the central processing circuit.

15. The method of signal processing of claim 14 wherein the telephone system is a wireless digital key telephone system for processing the transmission of audio and network signals and the wireless digital key telephone system further comprises a telephone exchange comprising:
a central processing circuit from controlling the operation of the telephone exchange;
a memory device electrically connected to the central processing circuit for storing programs and data;
a network exchange module stored in the memory device for processing the transmission of the network signals between the telephone exchange and the extension;
an audio exchange module stored in the memory device for processing the transmission of the audio signals between the telephone exchange and the extensions; and
a transceiver electrically connected to the central processing circuit for wirelessly transmitting and receiving network and audio signals through an antenna;
the extension further comprising:
a transceiver electrically connected to the central processing circuit for wirelessly transmitting the network and audio signals to the antenna of the telephone exchange and receiving the network and audio signals transmitted from the antenna of the telephone exchange;
the method of signal processing further comprising:
the transceiver for transmitting the network signals received from the network port and the audio signals received from the microphone to the telephone exchange;
the transceiver for the network and audio exchange modules of the telephone exchange processing the network and audio signals then transmitting the network and audio signals from the transceiver to the transceivers of other extensions, and the other extensions outputting the network and audio signals from the speaker and network port respectively.

16. The method of signal processing of claim 15 wherein the telephone exchange further comprises:
a network controlled electrically connected to the central processing circuit; and
a network port for transmitting the network signals outputted from the central processing circuit to the network port in order to transmit the network signals received from the network port to the central processing circuit.

17. The method of signal processing of claim 16 wherein the signal transmission of the network controller of the telephone exchange and the network controller of each extension meet the IEEE 802.3 communication protocol defined by IEEE.

18. The method of signal processing of claim 16 wherein the network port of the telephone exchange and the network port of the extension are all of the media type, 10base-T.

19. The method of signal processing of claim 16 wherein the network controller of the telephone exchange and the network controller of the extension are all repeaters for relaying the network signals.

20. The method of signal processing of claim 15 wherein the telephone exchange further comprises:
an audio processing circuit electrically connected to the central processing circuit; and
a transmission port for transmitting the audio signals outputted from the central processing circuit to the transmission port or transmitting the audio signals received from the transmission port to the central processing circuit.

21. The method of signal processing of claim 20 wherein the audio processing circuit of the telephone exchange comprises:
a Digital-To-Analog converter for transforming the digital audio signals outputted from the central processing unit to the corresponding analog audio signals; and
an Analog-To-Digital converter for transforming the analog audio signals received from the microphone to the corresponding digital audio signals.

22. The method of signal processing of claim 15 wherein the transceiver of the telephone exchange and the transceiver of the extension meet the IEEE 802.11 communication protocol defined by IEEE.

23. The method of signal processing of claim 15 wherein the transceiver of the telephone exchange and the transceiver of the extension transmit audio and network signals by DSSS.

24. The method of signal processing of claim 15 wherein the transceiver of the telephone exchange and the transceiver of the extension transmitting audio and network signals by CDMA.

25. The method of signal processing of claim 14 wherein the network port of the extension is electrically connected to a computer system.

26. The method of signal processing of claim 14 wherein the audio processing circuit of the extension comprises:
a Digital-To-Analog converter for transforming the digital audio signals outputted from the central processing unit to the corresponding analog audio signals; and
an Analog-To-Digital converter for transforming the analog audio signals received from the microphone to the corresponding digital audio signals.
